(19) United States
(12) Patent Application Publication
(10) Pub. No.: US 2025/0067937 A1
(43) Pub. Date: Feb. 27, 2025

(54) INDIVIDUAL GRATING FABRICATION AND ASSEMBLY

(71) Applicant: Applied Materials, Inc., Santa Clara, CA (US)

(72) Inventors: Michael Alexander WEINSTEIN, San Francisco, CA (US); Rutger MEYER TIMMERMAN THIJSSEN, Sunnyvale, CA (US)

(21) Appl. No.: 18/812,575

(22) Filed: Aug. 22, 2024

Related U.S. Application Data
(60) Provisional application No. 63/578,794, filed on Aug. 25, 2023.

(51) Int. Cl. F21V 8/00; G02B 27/01

(52) U.S. Cl. CPC G02B 6/34; G02B 5/1819; G02B 5/1847; G02B 27/0172

(57) ABSTRACT

The present disclosure generally provides waveguide combiners and methods thereof. The waveguide combiners include a substrate. A first grating is disposed over the substrate. The first grating includes a first device structure. A first coating layer is disposed over the first device structure. A first donor substrate is disposed over the first coating layer. A second grating is disposed over the substrate. The second grating includes a second device structure. A second coating layer is disposed over the second device structure. A second donor substrate is disposed over the second coating layer. An encapsulation layer is disposed over the first grating and the second grating.

### CROSS-REFERENCE TO RELATED APPLICATIONS

This application claims priority to U.S. Provisional Patent Application No. 63/578,794, filed Aug. 25, 2023, the entirety of which is herein incorporated by reference.

### BACKGROUND

### Field

Embodiments described herein generally relate to a waveguide combiner. More specifically, embodiments described herein relate to waveguide gratings and methods of fabricating waveguide combiners.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses that display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

### SUMMARY

In an embodiment, the present disclosure generally provides waveguide combiners. The waveguide combiners include a substrate. A first grating is disposed over the substrate. The first grating includes a first device structure. A first coating layer is disposed over the first device structure. A first donor substrate is disposed over the first coating layer. A second grating is disposed over the substrate. The second grating includes a second device structure. A second coating layer is disposed over the second device structure. A second donor substrate is disposed over the second coating layer. A third donor substrate is disposed over the third coating layer. An encapsulation layer is disposed over the first grating and the second grating.

In another embodiment, the present disclosure generally provides methods of forming waveguide combiners. The methods include disposing a first coating layer over a first donor substrate. A first device structure is disposed over the first coating layer. A second coating layer is disposed over a second donor substrate. The second device structure is disposed over the second coating layer. The first device structure is transferred to a waveguide substrate, in which transferring the first device structure includes inverting the first donor substrate and disposing the first device structure over the waveguide substrate. The second device structure is transferred to the waveguide substrate, in which transferring the second device structure includes inverting the second donor substrate and disposing the second device structure over the waveguide substrate. An encapsulation layer is disposed over the first coating layer and the second coating layer.

In another embodiment, the present disclosure generally provides methods of forming waveguide combiners. The methods include disposing a first device structure over a waveguide substrate. A debonding layer is disposed over a donor substrate. A second device structure is disposed over the donor substrate. A coating layer id disposed over the second device structure. The second device structure is removed from the donor substrate using a transfer substrate. The second device structure is transferred to the waveguide substrate. An encapsulation layer is disposed over the coating layer.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a perspective, frontal view of a waveguide combiner according to embodiments described herein.

FIG. 1B is a schematic, cross-sectional views of a waveguide combiner according to embodiments described herein.

FIG. 1C is a schematic, cross-sectional views of a waveguide combiner according to embodiments described herein.

FIG. 2 is a flow diagram of a method for forming a waveguide combiner, according to certain embodiments.

FIGS. 3A-3M are schematic, cross-sectional views of a portion of a device material during a method for forming a waveguide combiner according to certain embodiments.

FIG. 4 is a flow diagram of a method for forming a waveguide combiner, according to certain embodiments.

FIGS. 5A-5J are schematic, cross-sectional views of a portion of a device material during a method for forming a waveguide combiner according to certain embodiments.

FIGS. 6A and 6B are schematic, frontal views of a first donor substrate according to embodiments described herein.

FIGS. 7A and 7B are schematic, frontal views of a second donor substrate according to embodiments described herein.

FIGS. 8A and 8B are schematic, frontal views of a third donor substrate according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein generally relate to optical devices. More specifically, embodiments described herein relate to waveguide combiners and methods of fabricating and assembling waveguide combiners. In various embodiments, techniques are provided to fabricate waveguide combiners by bonding a first grating from a first donor substrate, a second grating from a second donor substrate, and a third grating from a third donor substrate, to a substrate, e.g., glass, thereby allowing for efficient waveguide processing. While the present disclosure describes a first grating, a second grating, and a third grating, any number of gratings may be disposed on the waveguide combiner. The present disclosure may allow for higher yields waveguide manufacturing, and the creation of curved waveguide devices with the use of specialized carrier substrates. Additionally, a reduction in manufacturing costs may be achieved by individualized repair processes, in which a first grating, a second grating, and/or a third grating of a waveguide combiner may be repaired without the need to replace the entire waveguide combiner.

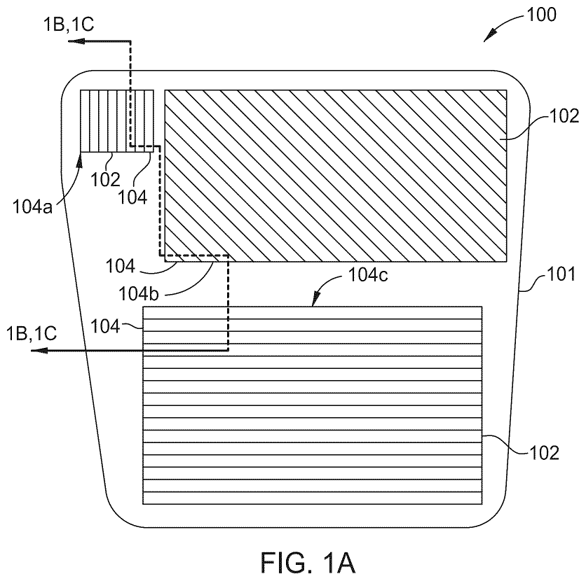

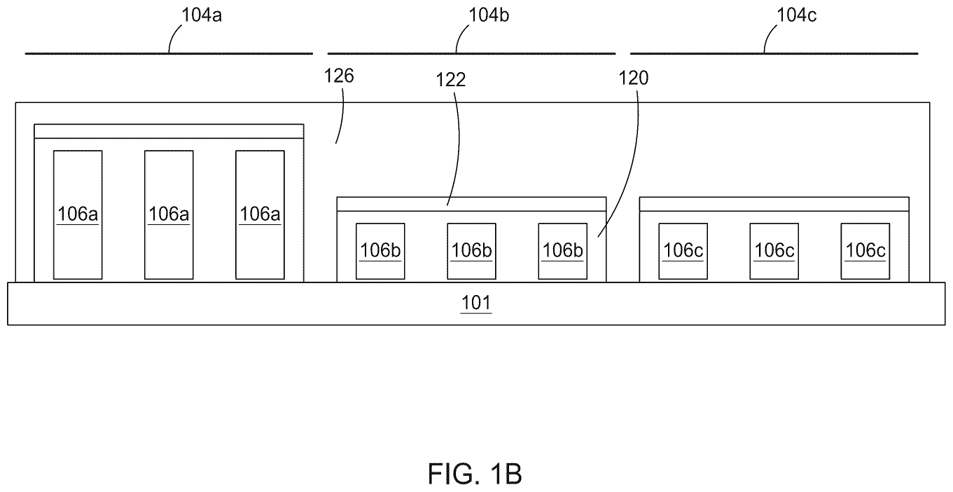

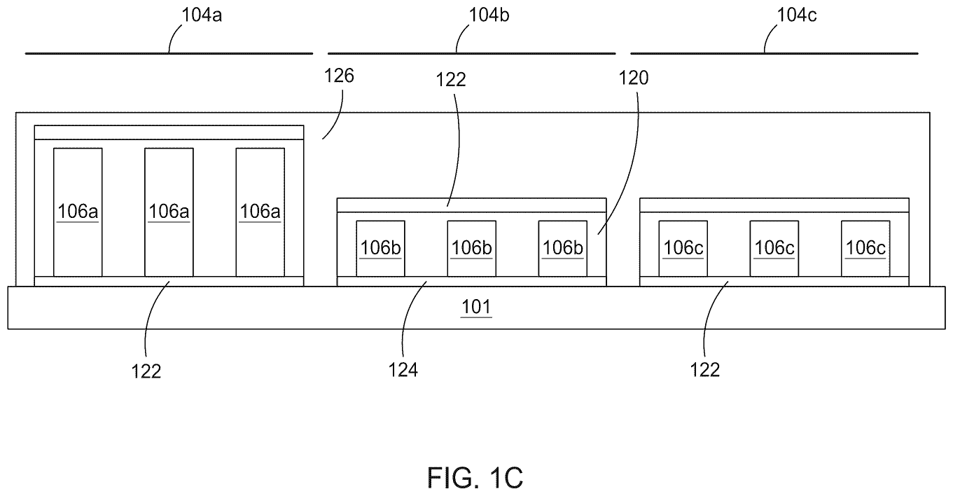

FIG. 1A illustrates a perspective, frontal view of a waveguide combiner 100. It is to be understood that the waveguide combiner 100 described below is an exemplary waveguide combiner. The waveguide combiner 100 is an augmented reality waveguide combiner. The waveguide combiner 100 includes a plurality of device structures 102 disposed on a substrate 101, e.g., a waveguide substrate. While FIG. 1A shows the plurality of device structures only disposed over a top surface of the waveguide combiner 100, the plurality of device structures may be independently disposed on a top side or a bottom side of the waveguide combiner 100. The substrate 101 may be of varying shapes, thicknesses, and diameters. For example, the substrate 101 may have a diameter of about 50 mm to about 500 mm. The substrate 101 may have a circular, rectangular, or square shape. The substrate 101 may have a thickness of between about 300 μm to about 1 mm.

The substrate 101 can be any substrate used in the art, and can be either opaque or transparent to a chosen wavelength of light, depending for the use of the substrate 101 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the substrate 101 includes, but is not limited to, a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the substrate 101 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 101 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titatium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), calcium oxide (CaO), or combinations thereof.

The device structures 102 can be nanostructures having sub-micron dimensions, e.g., nano-sized dimensions, such as critical dimensions less than 1 μm. Regions of the device structures 102 can correspond to one or more gratings 104, such as a first grating 104a, a second grating 104b, and a third grating 104c. The waveguide combiner 100 includes at least the first grating 104a corresponding to an input coupling grating and the third grating 104c corresponding to an output coupling grating. The waveguide combiner 100 can include the second grating 104b corresponding to an intermediate grating.

The first grating 104a has first device structures 106a. Although only nine first device structures 106a are shown on the substrate 101, any number of first device structures 106a may be disposed on the substrate 101. The second grating 104b has second device structures 106b. Although only twenty-six second device structures are shown on the substrate 101, any number of second device structures 106b may be disposed on the substrate 101. The third grating 104c has third device structures 106c. Although only fourteen third device structures are shown on the substrate 101, any number of third device structures 106c may be disposed on the substrate 101.

The device structures 102 and the substrate 101 can include a different material. The substrate 101 includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the device structures 102 include silicon carbide, silicon oxycarbide, titanium oxide, silicon oxide, vanadium oxide, aluminum oxide, aluminum-doped zinc oxide, indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

FIG. 1B is a schematic, cross-sectional view of a the waveguide combiner 100. The first device structures 106a, the second device structures 106b, and the third device structures 106c can independently include substantially vertical device structures, binary device structures, blazed device structures, staircase device structures, or a combination thereof. A coating layer 120 is disposed over the device structures 102, e.g., the first device structures 106a, the second device structures 106b, and the third device structures 106c. The coating layer 120 can include one or more of a silicon-based material, a silicon nitride-based material, an aluminum-based material, or a combination thereof. In some embodiments, the coating layer 120 can be disposed between the device structures 102, e.g., the first device structures 106a, the second device structures 106b, and the third device structures 106c, and the substrate 101. A coating layer 120 that is disposed between the device structures 102 and the substrate 101 can couple and/or bond the device structures 102 to the substrate 101.

In embodiments, the coating layer 120 may include separate layers, or the coating layer 120 may be a single layer (not shown) that wraps around the substrate 101 to coat the top and bottom of the substrate 101.

Alternatively, as shown in FIG. 1C, an adhesive layer 124 is disposed between the device structures 102, e.g., the first device structures 106a, the second device structures 106b, and the third device structures 106c, and the substrate 101. The adhesive layer 124 can include a material having a refractive index of about 1.0 to about 1.8. In some embodiments, which can be combined with other embodiments, the adhesive layer 124 can include an aerogel material, an epoxy material, or a substantially transparent material suitable to bond the device structures 102 to the substrate 101. The adhesive layer 124 disposed between the device structures 102 and the substrate 101 can couple and/or bond the device structures 102 to the substrate 101.

Optionally, a donor substrate 122 is disposed over the coating layer 120. The donor substrate 122 may include substrates of any suitable material, including, but not limited to, amorphous dielectrics, non-amorphous dielectrics, crystalline dielectrics, polymers, or combinations thereof. In some embodiments, the donor substrate 122 includes, but is not limited to, a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. For example, the donor substrate 122 can include silicon.

A encapsulation layer 126 is disposed over the first device structures 106a of the first grating 104a, the second device structures 106b of the second grating 104b, and the third device structures 106c of the third grating 104c. The encapsulation layer 126 includes, but is not limited to, aluminum, silver, gold, chromium, silicon nitride, silicon oxide, or combinations thereof. Example of the encapsulation layer 126 includes silicon dioxide, aluminum oxide, magnesium oxide, or combinations thereof. The encapsulation layer 126 may be formed using one or more vapor deposition processes which utilize plasma such as PVD or sputtering processes, a furnace CVD (FCVD) process, a PE-CVD process, a PE-ALD process, or other plasma processes.

In one or more examples, the encapsulation layer 126 may be deposited by a PVD process which includes generating ozone or an oxygen plasma while depositing the encapsulation layer 126. For example, silver may be deposited in a magnetron sputtering PVD chamber using a silicon target and depositing reactively with a plasma containing argon and oxygen (Ar/O₂). The encapsulation layer 126 may have a thickness of about 10 nm to about 200 nm, or greater.

Optionally, the substrate 101 can include a curved substrate. The curved substrate can include a substrate having one or more bends, curves, or a combination thereof. The methods described herein can allow for curved substrates to be utilized due to the individualized fabrication of the waveguide, e.g., disposing an incoupler grating, pupil expander grating, or an outcoupler grating individually on the curved substrate.

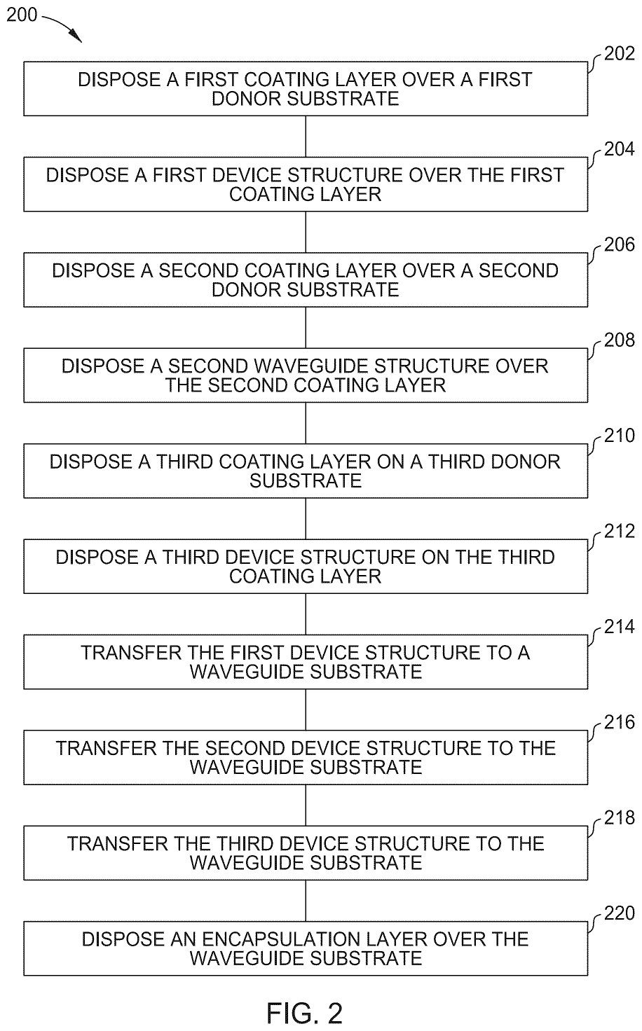

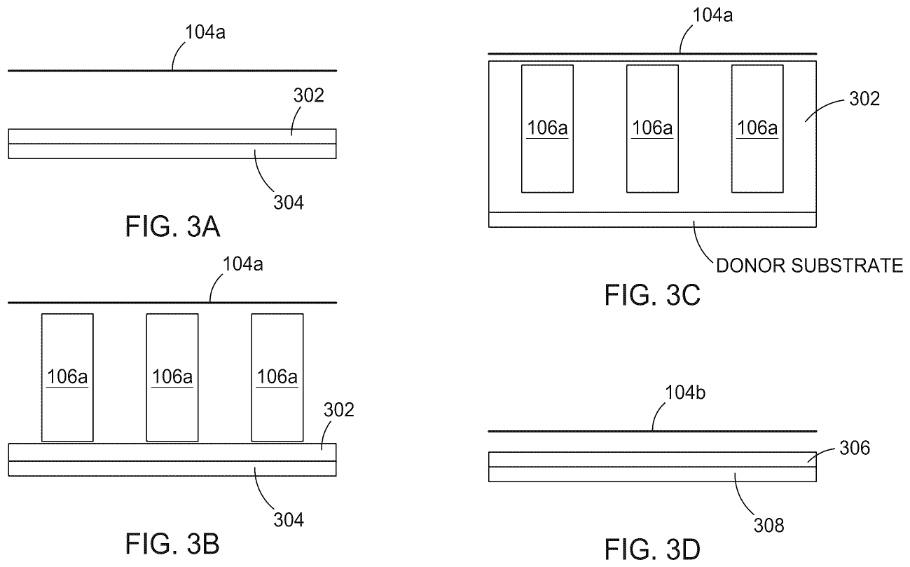

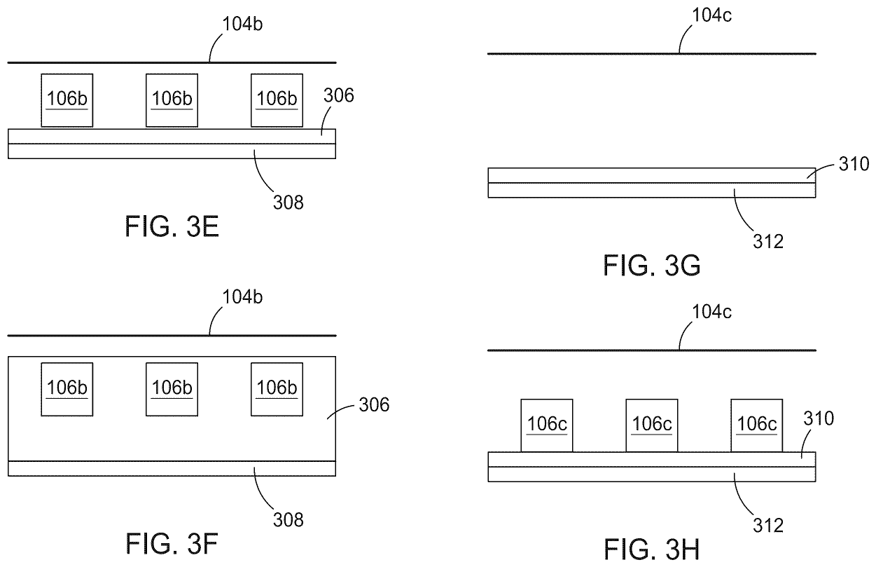

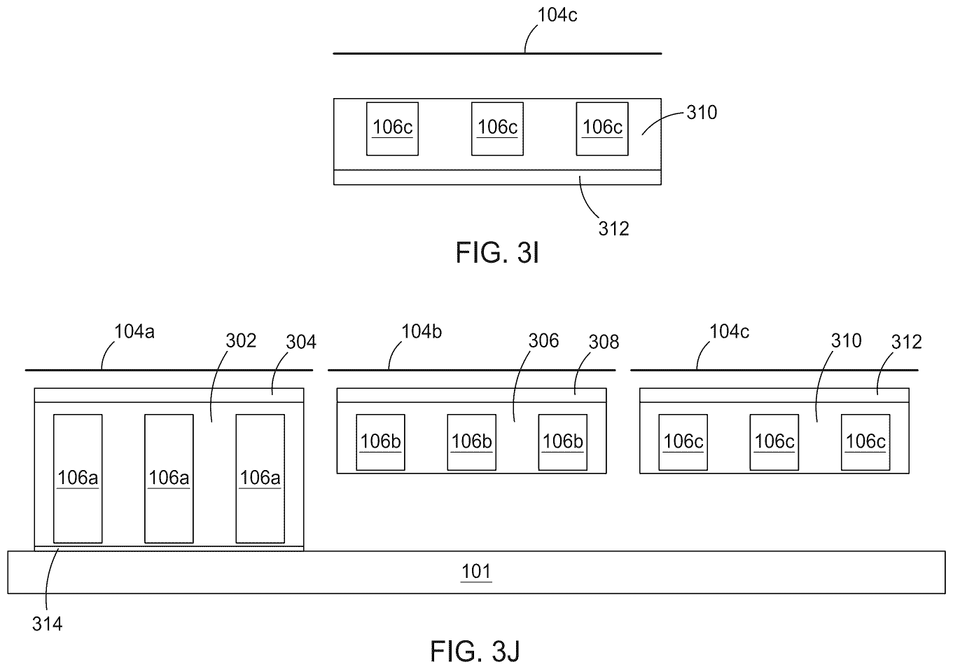

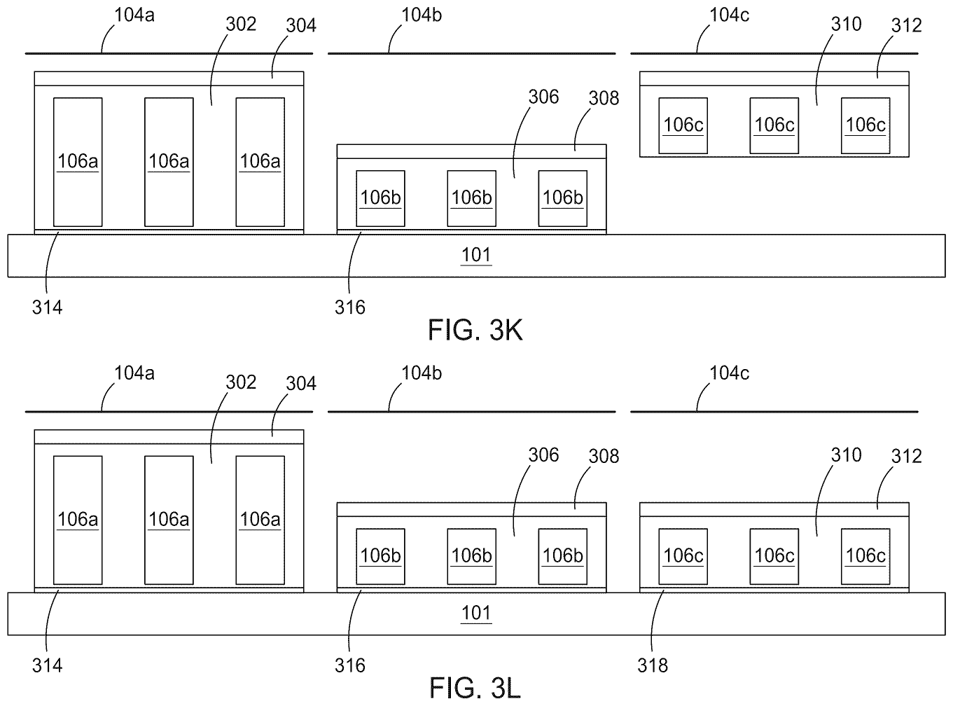

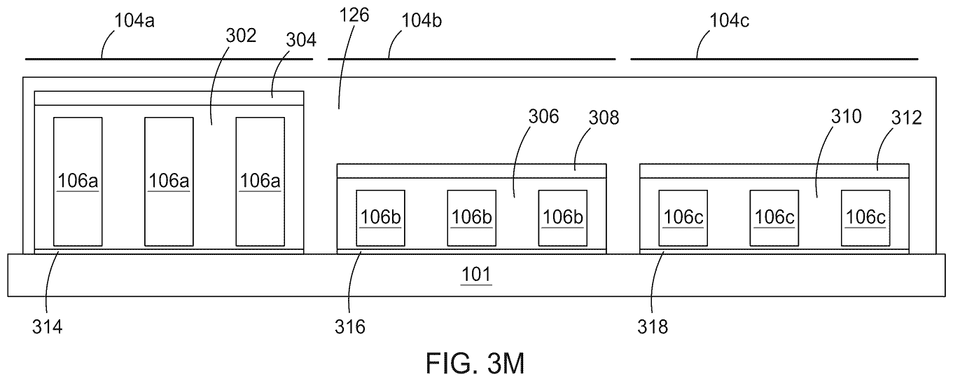

FIG. 2 is a flow diagram of a method 200 for forming a waveguide combiner 100. FIGS. 3A-3M show portions of device structures 102. In one embodiment, the device structures 102 include at least one of silicon oxycarbide (SiOC), titanium dioxide (TiO₂), silicon dioxide (SiO₂), vanadium (IV) oxide (VOₓ), aluminum oxide (Al₂O₃), indium tin oxide (ITO), zinc oxide (ZnO), tantalum pentoxide (Ta₂O₅), silicon nitride (Si₃N₄), titanium nitride (TiN), and zirconium dioxide (ZrO₂) containing materials.

At operation 202, as shown in FIG. 3A, a first coating layer 302 is disposed over a first donor substrate 304. The first coating layer 302 can include the coating layer 120 as described herein. For example, the first coating layer 302 can include one or more of a silicon-based material, a silicon nitride-based material, an aluminum-based material, or a combination thereof. The first donor substrate 304 can include the donor substrate 122 as described herein. For example, the first donor substrate 304 can include a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. The first coating layer 302 can be disposed on the first donor substrate 304 using one or more deposition processes, e.g., chemical vapor deposition, physical vapor desorption, plasma enhanced deposition, or a combination thereof.

At operation 204, as shown in FIG. 3B, the first device structures 106a are disposed over the first coating layer 302. The first device structures 106a are disposed by depositing device material over portions of the first donor substrate 304. The device material is then patterned to form the first device structures 106a. The device material can be deposited via one or more deposition processes, e.g., chemical vapor deposition, physical vapor desorption, plasma enhanced deposition, or a combination thereof. Optionally, as shown in FIG. 3C, the first coating layer 302 is deposited again, such that the first coating layer 302 is disposed between the first device structures 106a. The patterning process to form the first device structures 106a includes, but is not limited to, nano-imprint lithography, reactive ion etching, ion beam etching, or combinations thereof. In some embodiments, which can be combine with other embodiments, the first coating layer 302 can be disposed over a top surface of the first device structures 106a. A first coating layer 302 disposed over the top surface of the first device structures 106a may enhanced adhesion between the substrate 101 and the first device structures 106a.

At operation 206, as shown in FIG. 3D, a second coating layer 306 is disposed over a second donor substrate 308. The second coating layer 306 can include the coating layer 120 as described herein. For example, the second coating layer 306 can include one or more of a silicon-based material, a silicon nitride-based material, an aluminum-based material, or a combination thereof. The second donor substrate 308 can include the donor substrate 122 as described herein. For example, the second donor substrate 308 can include a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. The second coating layer 306 can be disposed on the second donor substrate 308 using one or more deposition processes, e.g., chemical vapor deposition, physical vapor desorption, plasma enhanced deposition, or a combination thereof.

At operation 208, as shown in FIG. 3E, the second device structures 106b are disposed over the second coating layer 306. The second device structures 106b are disposed by depositing device material over portions of the second donor substrate 308. The device material is then patterned to form the second device structures 106b. The device material can be deposited via one or more deposition processes, e.g., chemical vapor deposition, physical vapor desorption, plasma enhanced deposition, or a combination thereof. Optionally, as shown in FIG. 3F, the second coating layer 306 is deposited again, such that the second coating layer 306 is disposed between the second device structures 106b. The patterning process to form the second device structures 106b includes, but is not limited to, nano-imprint lithography, reactive ion etching, ion beam etching, or combinations thereof. In some embodiments, which can be combined with other embodiments, the second coating layer 306 can be disposed over a top surface of the second device structures 106b. A second coating layer 306 disposed over the top surface of the second device structures 106b may enhanced adhesion between the substrate 101 and the second device structures 106b.

At operation 210, as shown in FIG. 3G, a third coating layer 310 is disposed over a third donor substrate 312. The third coating layer 310 can include the coating layer 120 as described herein. For example, the third coating layer 310 can include one or more of a silicon-based material, a silicon nitride-based material, an aluminum-based material, or a combination thereof. The third donor substrate 312 can include the donor substrate 122 as described herein. For example, the third donor substrate 312 can include a silicon-containing material, a silicon and oxygen containing compound, a germanium-containing material, an indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, an indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. The third coating layer 310 can be disposed on the third donor substrate 312 using one or more deposition processes, e.g., chemical vapor deposition, physical vapor desorption, plasma enhanced deposition, or a combination thereof.

At operation 212, as shown in FIG. 3H, the third device structures 106c are disposed over the third coating layer 310. The third device structures 106c are disposed by depositing device material over portions of the third donor substrate 312. The device material is then patterned to form the third device structures 106c. The device material can be deposited via one or more deposition processes, e.g., chemical vapor deposition, physical vapor desorption, plasma enhanced deposition, or a combination thereof. Optionally, as shown in FIG. 3I, the third coating layer 310 is deposited again, such that the third coating layer 310 is disposed between the third device structures 106c. The patterning process to form the third device structures 106c includes, but is not limited to, nano-imprint lithography, reactive ion etching, ion beam etching, or combinations thereof. In some embodiments, which can be combined with other embodiments, the third coating layer 310 can be disposed over a top surface of the third device structures 106c. A third coating layer 310 disposed over the top surface of the third device structures 106c may enhanced adhesion between the substrate 101 and the third device structures 106c.

At operation 214, as shown in FIG. 3J, the first device structure 106a is disposed over the substrate 101. In some embodiments, the first donor substrate 304 is inverted and the first device structures 106a are disposed over a top surface of the substrate 101. Optionally, a first adhesive layer 314 is disposed between the first coating layer 302 and the substrate 101. The first adhesive layer 314 can include any of the adhesive layer 124, as described herein. For example, the first adhesive layer 314 can include a material having a refractive index of about 1.0 to about 1.8. As a further example, the first adhesive layer 314 can include an aerogel material, an epoxy material, or a substantially transparent material suitable to bond the first device structures 106a and/or the first coating layer 302 to the substrate 101. The first adhesive layer 314 is disposed between the first coating layer 302 or the first device structures 106a and the substrate 101 such that the first adhesive layer 314 can couple and/or bond the first device structures 106a or the first coating layer 302 to the substrate 101.

At operation 216, as shown in FIG. 3K, the second device structure 106b is disposed over the substrate 101. In some embodiments, the second donor substrate 308 is inverted and the second device structures 106b are disposed over a top surface of the substrate 101. Optionally, a second adhesive layer 316 is disposed between the second coating layer 306 and the substrate 101. The second adhesive layer 316 can include any of the adhesive layer 124, as described herein. For example, the second adhesive layer 316 can include a material having a refractive index of about 1.0 to about 1.8. As a further example, the second adhesive layer 316 can include an aerogel material, an epoxy material, or a substantially transparent material suitable to bond the second device structures 106b and/or the second coating layer 306 to the substrate 101. The second adhesive layer 316 is disposed between the second coating layer 306 or the second device structures 106b and the substrate 101 such that the second adhesive layer 316 can couple and/or bond the second device structures 106b or the second coating layer 306 to the substrate 101.

At operation 218, as shown in FIG. 3L, the third device structure 106c is disposed over the substrate 101. In some embodiments, the third donor substrate 312 is inverted and the third device structure 106c are disposed over a top surface of the substrate 101. Optionally, a third adhesive layer 318 is disposed between the third coating layer 310 and the substrate 101. The third adhesive layer 318 can include any of the adhesive layer 124, as described herein. For example, the third adhesive layer 318 can include a material having a refractive index of about 1.0 to about 1.8. As a further example, the third adhesive layer 318 can include an aerogel material, an epoxy material, or a substantially transparent material suitable to bond the third device structures 106c and/or the third coating layer 310 to the substrate 101. The third adhesive layer 318 is disposed between the third coating layer 310 or the third device structures 106c and the substrate 101 such that the third adhesive layer 318 can couple and/or bond the second device structures 106b or the second coating layer 306 to the substrate 101.

At operation 220, as shown in FIG. 3M, an encapsulation layer 126 is disposed over the first donor substrate 304, the second donor substrate 308, and the third donor substrate 312. The encapsulation layer 126 may be formed using one or more vapor deposition processes which utilize plasma such as PVD or sputtering processes, a furnace CVD (FCVD) process, a PE-CVD process, a PE-ALD process, or other plasma processes. Optionally, one or more additional processes, e.g., polishing, dicing, edge blackening, or a combination thereof, may be performed following encapsulation.

The waveguide combiner 100 of the present disclosure may be repaired or reworked by removing the first device structure 106a, the second device structure 106b, and/or the third device structure 106c and remounting the same structure or mounting a replacement structure of the same type as the removed structure. Similarly, a curved waveguide combiner may be repaired or reworked by removing the first device structure 106a, the second device structure 106b, and/or the third device structure 106c and remounting the same structure or mounting a replacement structure of the same type as the removed structure.

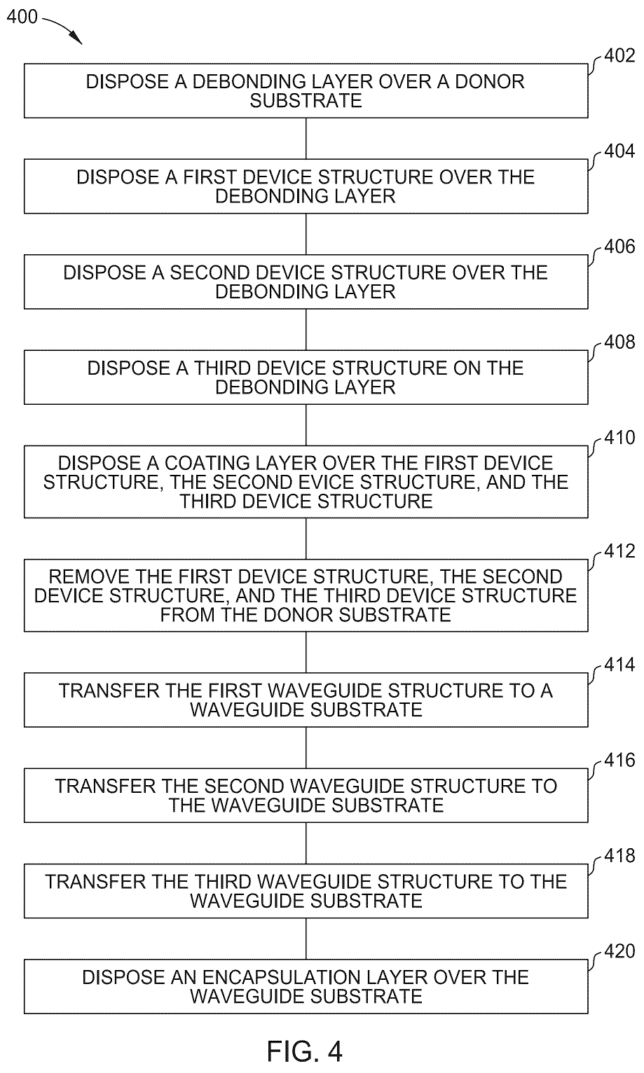

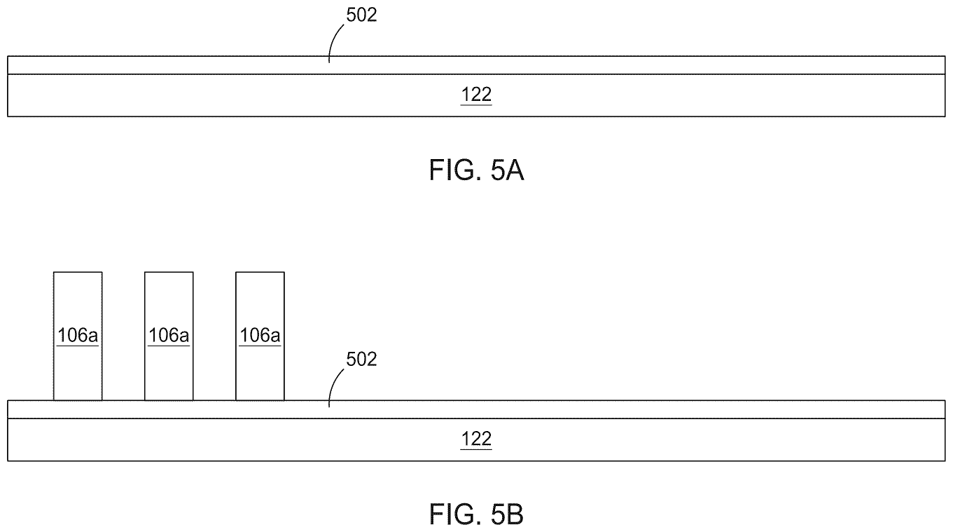

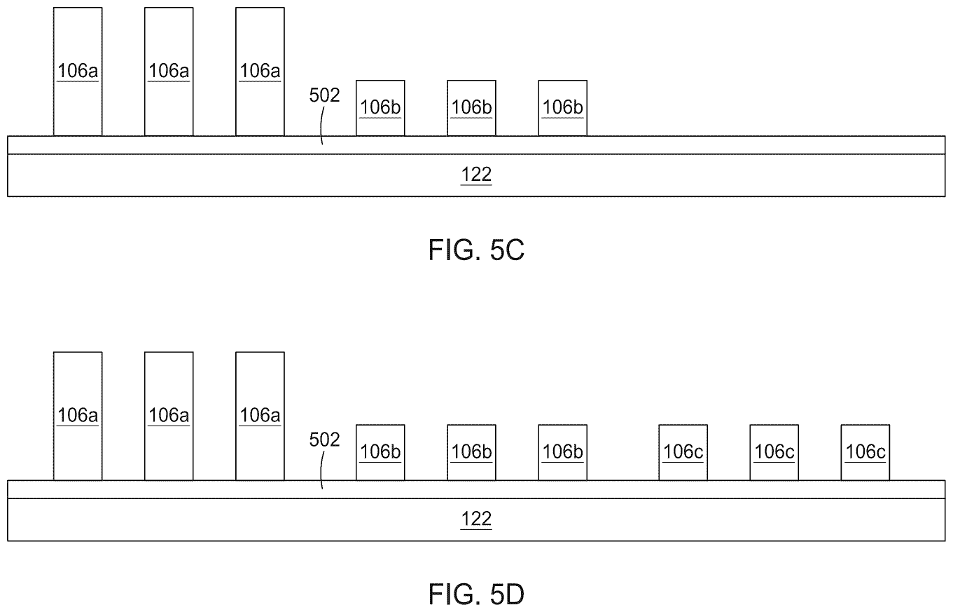

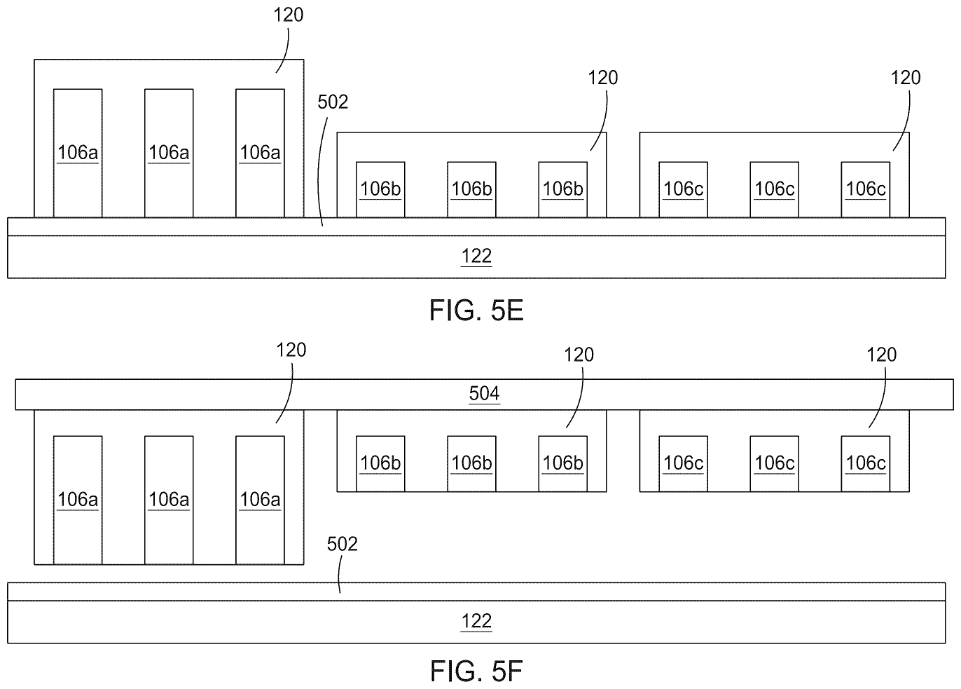

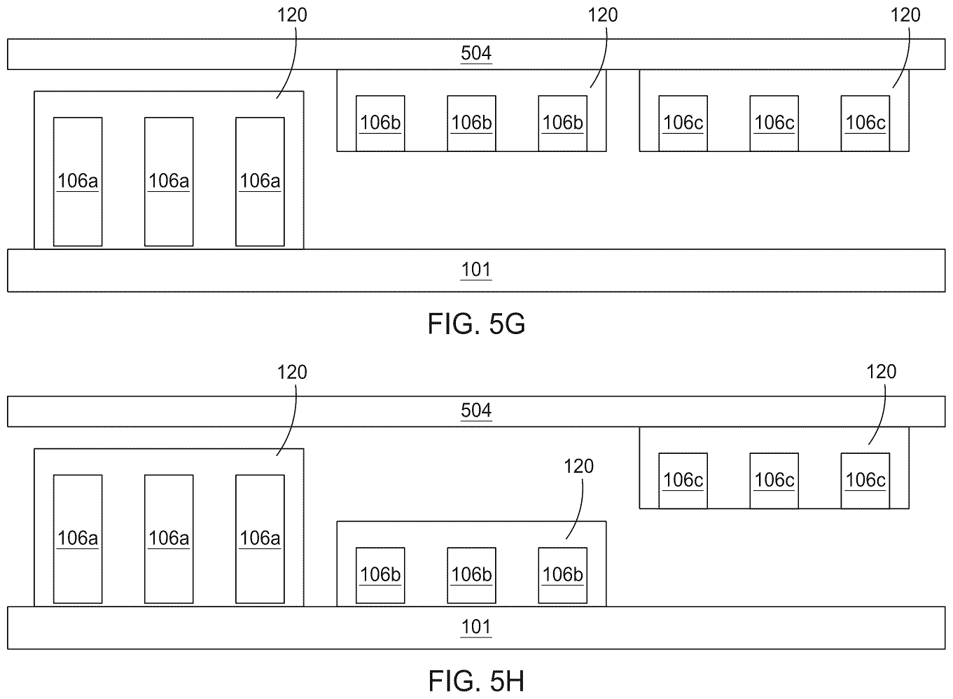

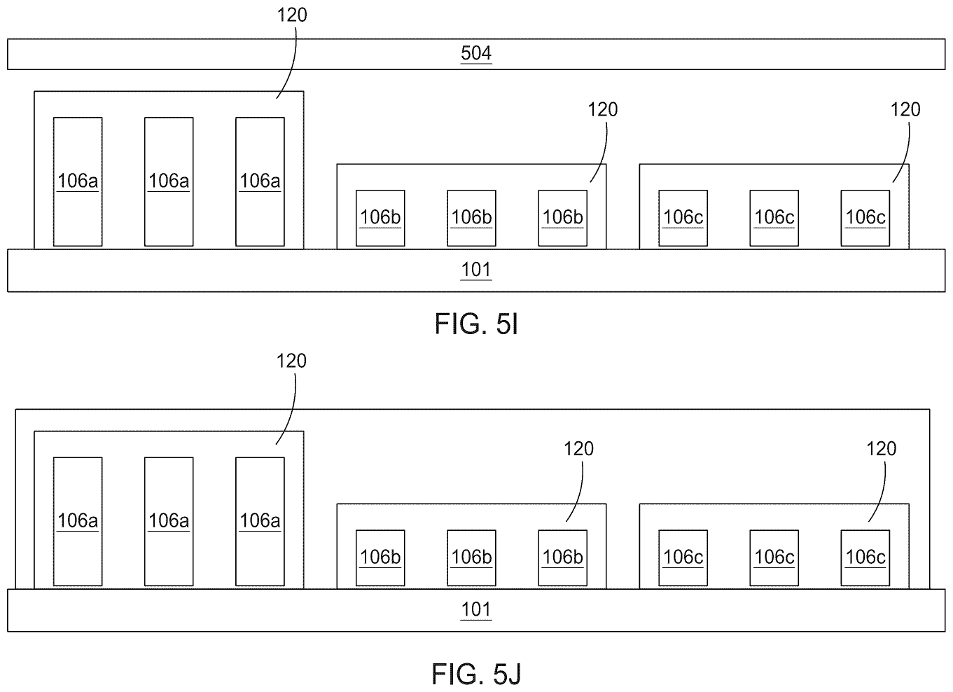

FIG. 4 is a flow diagram of a method 400 for forming a waveguide combiner 100. FIGS. 5A-5M show portions of device structures 102. In one embodiment, the device structures 102 include at least one of silicon oxycarbide (SiOC), titanium dioxide (TiO₂), silicon dioxide (SiO₂), vanadium (IV) oxide (VOₓ), aluminum oxide (Al₂O₃), indium tin oxide (ITO), zinc oxide (ZnO), tantalum pentoxide (Ta₂O₅), silicon nitride (Si₃N₄), titanium nitride (TiN), and zirconium dioxide (ZrO₂) containing materials.

At operation 402, as shown in FIG. 3A, a debonding layer 502 is disposed over a donor substrate 122. The debonding layer 502 can include the include one or more of a silicon-based material, a silicon nitride-based material, an aluminum-based material, or a combination thereof. The debonding layer 502 can be configured to remove and/or dissociate a device structure from the debonding layer, such that the debonding layer remains attached to the donor substrate 122, and the device structures de-bond or remove from the debonding layer 502. The debonding layer 502 can be disposed on the donor substrate 122 using one or more deposition processes, e.g., chemical vapor deposition, physical vapor desorption, plasma enhanced deposition, or a combination thereof.

At operation 404, as shown in FIG. 5B, the first device structures 106a are disposed over the debonding layer 502. The first device structures 106a can be disposed over the debonding layer 502 using one or more deposition processes, e.g., chemical vapor deposition, physical vapor desorption, plasma enhanced deposition, or a combination thereof. At operation 406, as shown in FIG. 5C, the second device structures 106b are disposed over the debonding layer 502. The second device structures 106b can be disposed over the debonding layer 502 using one or more deposition processes, e.g., chemical vapor deposition, physical vapor desorption, plasma enhanced deposition, or a combination thereof. At operation 408, as shown in FIG. 5D, the third device structures 106c are disposed over the debonding layer 502. The third device structures 106c can be disposed over the debonding layer 502 using one or more deposition processes, e.g., chemical vapor deposition, physical vapor desorption, plasma enhanced deposition, or a combination thereof.

At operation 410, as shown in FIG. 5E, a coating layer 120 is disposed over the first device structures 106a, the second device structures 106b, and the third device structures 106c. The coating layer 120 can include one or more of a silicon-based material, a silicon nitride-based material, an aluminum-based material, or a combination thereof. The coating layer 120 can be disposed over the first device structures 106a, the second device structures 106b, and the third device structures 106c using one or more deposition processes, e.g., chemical vapor deposition, physical vapor desorption, plasma enhanced deposition, or a combination thereof.

At operation 412, as shown in FIG. 5F, the first device structures 106a, the second device structures 106b, and the third device structures 106c are removed from the donor substrate 122 using a transfer substrate 504. The transfer substrate 504 includes a substrate capable of bonding to and/or adhering to the coating layer 120. For example, the transfer substrate 504 can include a polymer and/or inorganic material having an adhesive layer. In some embodiments, the transfer substrate 504 can include a tape material. The transfer substrate 504 can contact the coating layer 120 and remove the first device structure 106a, the second device structure 106b, and/or the third device structure 106c from the debonding layer 502. The debonding layer 502 may remain adhered to and/or in contact with the donor substrate 122.

At operation 414, as shown in FIG. 5G, the first device structure 106a is disposed over the substrate 101. In some embodiments, the transfer substrate 504 is disposed over the substrate 101, in which the first device structure 106a is disposed on the substrate 101 and bonded to the substrate 101. In some embodiments, the first device structures 106a are disposed over a top surface of the substrate 101. In some embodiments, an adhesive layer is disposed between the first device structure 106a and the substrate 101. The adhesive layer can include any of the adhesive layer 124, as described herein. In some embodiments, the substrate 101 can be surface treated, e.g., chemically treated via a chemical treatment process or plasma treated via a plasma treatment process, to enhance adhesion between the first device structure 106a and the substrate 101.

At operation 416, as shown in FIG. 5H, the second device structure 106b is disposed over the substrate 101. In some embodiments, the transfer substrate 504 is disposed over the substrate 101, in which the second device structure 106b is disposed on the substrate 101 and bonded to the substrate 101. In some embodiments, the second device structures 106b are disposed over a top surface of the substrate 101. In some embodiments, an adhesive layer is disposed between the second device structure 106b and the substrate 101. The adhesive layer can include any of the adhesive layer 124, as described herein. In some embodiments, the substrate 101 can be surface treated, e.g., chemically treated or plasma treated, to enhance adhesion between the second device structure 106b and the substrate 101.

At operation 418, as shown in FIG. 5I, the third device structure 106c is disposed over the substrate 101. In some embodiments, the transfer substrate 504 is disposed over the substrate 101, in which the third device structure 106c is disposed on the substrate 101 and bonded to the substrate 101. In some embodiments, the third device structure 106c is disposed over a top surface of the substrate 101. In some embodiments, an adhesive layer is disposed between the second device structure 106b and the substrate 101. The adhesive layer can include any of the adhesive layer 124, as described herein. In some embodiments, the substrate 101 can be surface treated, e.g., chemically treated or plasma treated, to enhance adhesion between the third device structure 106c and the substrate 101.

At operation 420, as shown in FIG. 5J, an encapsulation layer 126 is disposed over the coating layer 120 and substrate 101. The encapsulation layer 126 may be formed using one or more vapor deposition processes which utilize plasma such as PVD or sputtering processes, a furnace CVD (FCVD) process, a PE-CVD process, a PE-ALD process, or other plasma processes. Optionally, one or more additional processes, e.g., polishing, dicing, edge blackening, or a combination thereof, may be performed following encapsulation.

The waveguide combiner 100 of the present disclosure may be repaired or reworked by removing the first device structure 106a, the second device structure 106b, and/or the third device structure 106c and remounting the same structure or mounting a replacement structure of the same type as the removed structure. Similarly, a curved waveguide combiner may be repaired or reworked by removing the first device structure 106a, the second device structure 106b, and/or the third device structure 106c and remounting the same structure or mounting a replacement structure of the same type as the removed structure.

In operation, the waveguide combiner 100 may be optically coupled to a light emitter (LE) and a metrology/calibration instrument. In some embodiments, the light emitter may be a microdisplay. The light emitter may project an image into the first grating 104a, e.g., the incoupler gratings, of the waveguide combiner 100, and the metrology/calibration instrument may receive light from the third grating 104c, e.g., the outcoupler gratings, of the waveguide combiner 100. Measurements from the metrology/calibration instrument may be used in calibrating the light emitter to enable the image emitted from the third grating 104c, e.g., the outcoupler gratings, to be clear. In some embodiments, the light emitter may project into the first grating 104a, e.g., the incoupler gratings, from a concave side of the waveguide combiner 100 in embodiments of the present disclosure. Alternatively, the third grating 104c, e.g., the outcoupler gratings, of the waveguide combiner 100 may project the image from the concave side in embodiments of the present disclosure.

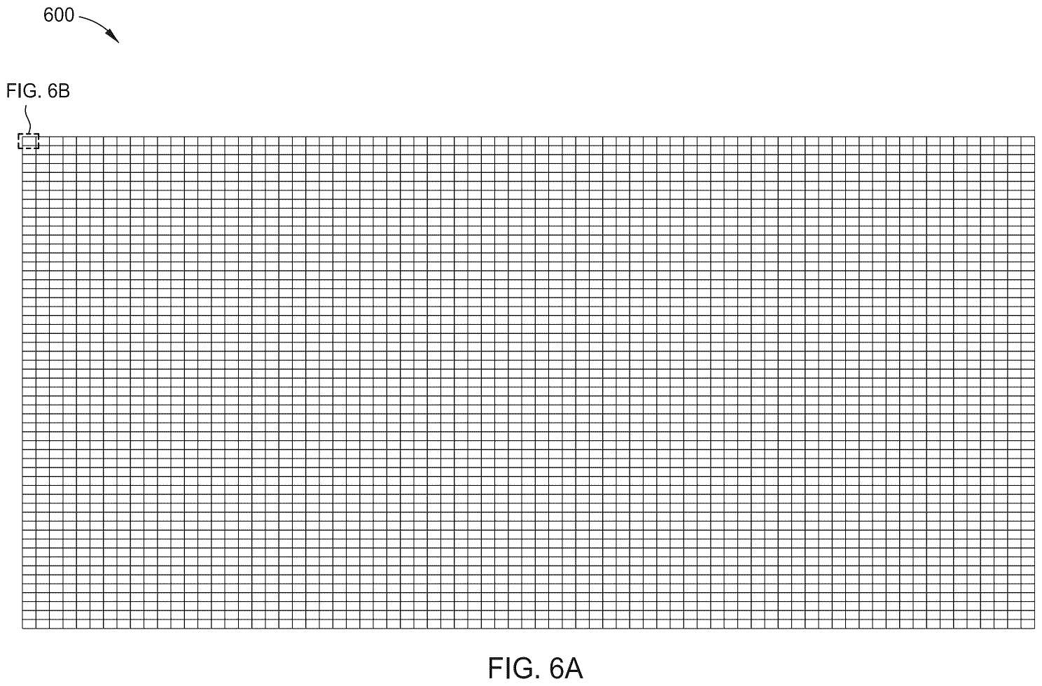

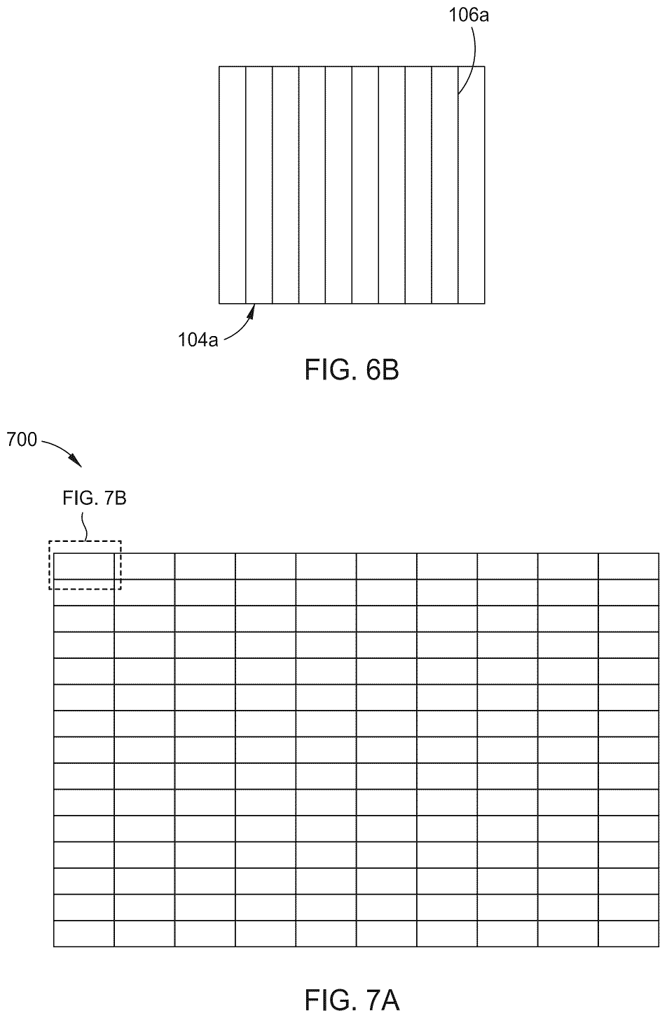

FIG. 6A is a schematic view of an arrangement600 of first gratings 104a, e.g., incoupler gratings, on the donor substrate 122, according to embodiments of the present disclosure. In some embodiments, about 1 to about 4000 first gratings 104a, e.g., incoupler gratings, may be formed on the donor substrate 122. In other embodiments of the present disclosure, about 1 to about 500 first gratings 104a may be formed on the donor substrate 122. Each first grating 104a may include one or more device structures, e.g., first device structures 106a, suitable for inclusion in a waveguide combiner, such as the waveguide combiner 100, shown in FIG. 1A. For example, each first grating 104a may include about nine first device structures 106a suitable for including in a waveguide combiner, as shown in FIG. 6B. In some embodiments, each first grating 104a may have a diameter of approximately 3 mm. In some embodiments, a first grating 104a may be diced off of the donor substrate 122 and used in manufacturing a waveguide combiner, as described herein.

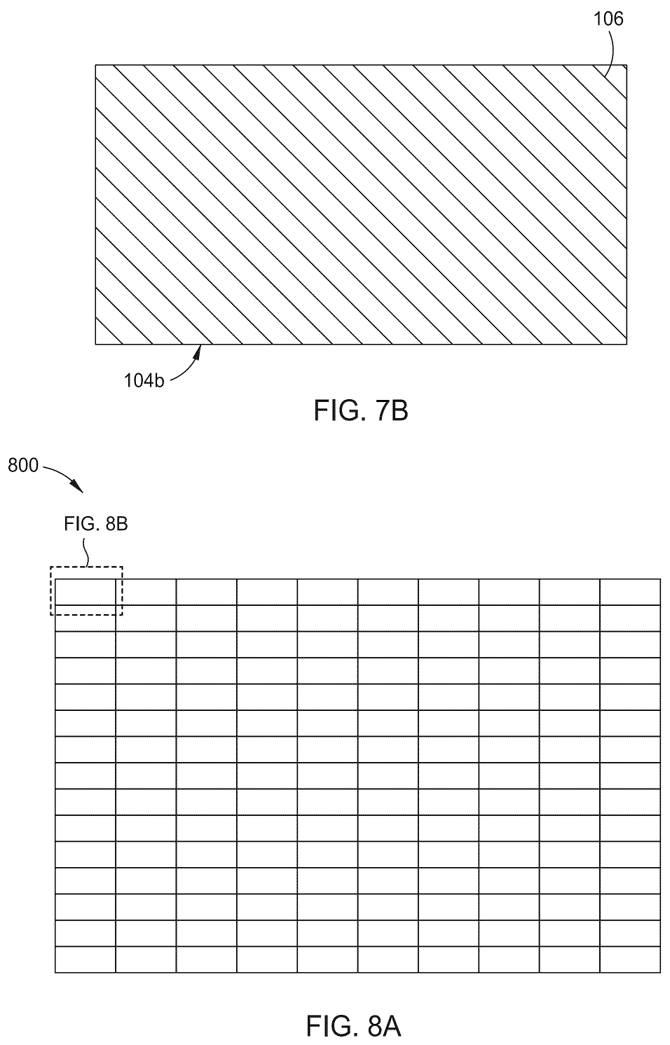

FIG. 7B is a schematic view of an arrangement 700 of second gratings 104b, e.g., pupil expander gratings, on the donor substrate 122, according to embodiments of the present disclosure. In some embodiments, about 1 to about 150 second gratings 104b, e.g., pupil expander gratings, may be formed on the donor substrate 122. In other embodiments of the present disclosure, about 1 to about 100 second gratings 104b may be formed on the donor substrate 122. Each second grating 104b may include one or more device structures, e.g., second device structures 106b, suitable for inclusion in a waveguide combiner, such as the waveguide combiner 100, shown in FIG. 1A. For example, each second grating 104b may include about twenty-six second device structures suitable for including in a waveguide combiner, as shown in FIG. 7B. In some embodiments, a second grating 104b may be diced off of the donor substrate 122 and used in manufacturing a waveguide combiner, as described herein.

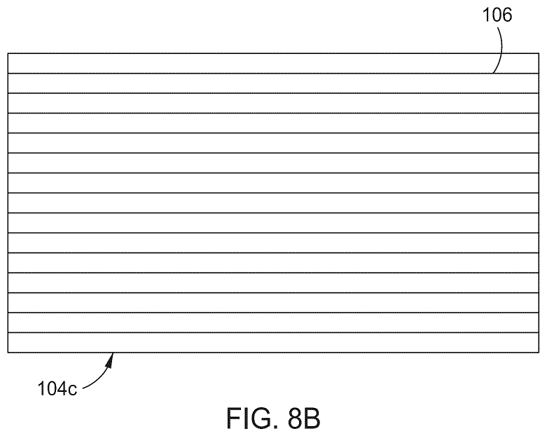

FIG. 8A is a schematic view of an arrangement 800 of third gratings 104c, e.g., outcoupler gratings, on the donor substrate 122, according to embodiments of the present disclosure. In some embodiments, about 1 to about 150 third gratings 104c, e.g., outcoupler gratings, may be formed on the donor substrate 122. In other embodiments of the present disclosure, about 1 to about 100 third gratings 104c may be formed on the donor substrate 122. Each third grating 104c may include one or more device structures, e.g., third device structures 106c, suitable for inclusion in a waveguide combiner, such as the waveguide combiner 100, shown in FIG. 1A. For example, each third grating 104c may include about fourteen third device structures suitable for including in a waveguide combiner, as shown in FIG. 8B. In some embodiments, a third gratings 104C may be diced off of the donor substrate 122 and used in manufacturing a waveguide combiner, as described herein.

Overall, the present disclosure provides improved methods of fabricating and assembling waveguide combiners. The methods can produce waveguide combiners by bonding an incoupler grating from a first donor substrate, a pupil expander grating from a second donor substrate, and an outcoupler grating from a third donor substrate, to a substrate, e.g., glass, thereby allowing for efficient waveguide processing. The present disclosure may allow for higher yields waveguide manufacturing, and the creation of curved waveguide devices with the use of specialized carrier substrates. Additionally, a reduction in manufacturing costs may be achieved by individualized repair processes, in which an incoupler grating, pupil expander grating, and/or outcoupler grating of a waveguide combiner may be repaired without the need to replace the entire waveguide combiner.

While the foregoing is directed to embodiments of the present disclosure, other and further embodiments of the disclosure may be devised without departing from the basic scope thereof, and the scope thereof is determined by the claims that follow.

What is claimed is:

1. A waveguide combiner, comprising:
a substrate; and
a first grating disposed over the substrate, the first grating comprising:
a first device structure;
a first coating layer disposed over the first device structure;
a first donor substrate disposed over the first coating layer;
a second grating disposed over the substrate, the second grating comprising:
a second device structure;
a second coating layer disposed over the second device structure;
a second donor substrate disposed over the second coating layer;
an encapsulation layer disposed over the first grating and the second grating.

2. The waveguide combiner of claim 1, wherein the first coating layer is disposed between the first device structure and an adjacent first device structure.

3. The waveguide combiner of claim 1, wherein the second coating layer is disposed between the second device structure and an adjacent second device structure.

4. The waveguide combiner of claim 1, further comprising:
a third grating disposed over the substrate, the third grating comprising:
a third device structure; and
a third coating layer disposed over the third device structure; and
a third donor substrate disposed over the third coating layer;
wherein the third coating layer is disposed between the third device structure and an adjacent third device structure.

5. The waveguide combiner of claim 1, wherein the first coating layer is further disposed between the first device structure and the substrate.

6. The waveguide combiner of claim 1, wherein the second coating layer is further disposed between the second device structure and the substrate.

7. A method of forming a waveguide combiner, comprising:
disposing a first coating layer over a first donor substrate;
disposing a first device structure over the first coating layer;
disposing a second coating layer over a second donor substrate;
disposing a second device structure over the second coating layer;
transferring the first device structure to a waveguide substrate, wherein transferring the first device structure comprises inverting the first donor substrate and disposing the first device structure over the waveguide substrate;
transferring the second device structure to the waveguide substrate, wherein transferring the second device structure comprises inverting the second donor substrate and disposing the second device structure over the waveguide substrate; and
disposing an encapsulation layer over the first coating layer and the second coating layer.

8. The method of claim 7, further comprising:
disposing a third coating layer over a third donor substrate;
disposing a third device structure over the third coating layer; and
transferring the third device structure to the waveguide substrate, wherein transferring the third device structure comprises inverting the third donor substrate and disposing the third device structure over the waveguide substrate.

9. The method of claim 7, wherein transferring the first device structure to the waveguide substrate further comprises performing a treatment process on a surface of the waveguide substrate.

10. The method of claim 9, wherein the treatment process is a chemical treatment process or a plasma treatment process.

11. The method of claim 7, wherein transferring the first device structure to the waveguide substrate further comprises disposing an adhesive layer between the first device structure and the waveguide substrate.

12. The method of claim 7 wherein transferring the second device structure to the waveguide substrate further comprises performing a treatment process on a surface of the waveguide substrate.

13. The method of claim 12, wherein the treatment process is a chemical treatment process or a plasma treatment process.

14. The method of claim 7, wherein transferring the second device structure to the waveguide substrate further comprises disposing an adhesive layer between the second device structure and the waveguide substrate.

15. The method of claim 7, wherein transferring the third device structure to the waveguide substrate further comprises performing a treatment process on a surface of the waveguide substrate.

16. The method of claim 15, wherein the treatment process is a chemical treatment process or a plasma treatment process.

17. The method of claim 7, wherein transferring the third device structure to the waveguide substrate further comprises disposing an adhesive layer between the third device structure and the waveguide substrate.

18. A method of forming a waveguide combiner, comprising:
Disposing a first device structure over a waveguide substrate;
disposing a debonding layer over a donor substrate;
disposing a second device structure over the donor substrate;
disposing a coating layer over the second device structure;
removing the second device structure, from the donor substrate using a transfer substrate;
transferring the second device structure to the waveguide substrate; and
disposing an encapsulation layer over the coating layer.

19. The method of claim 18, wherein the transfer substrate comprises an adhesive layer.

20. The method of claim 18, wherein removing the second device structure from the donor substrate comprises separating the second device structure from the debonding layer.
